(19) United States
(12) Patent Application Publication
(10) Pub. No.: US 2019/0041837 A1
(43) Pub. Date: Feb. 7, 2019

(54) REDUNDANT ACTIVE CONTROL SYSTEM COORDINATION

(71) Applicant: GM GLOBAL TECHNOLOGY OPERATIONS LLC, Detroit, MI (US)

(72) Inventors: David J. Elenich, Farmington Hills, MI (US); Yingmei Si, West Bloomfield, MI (US); Kelly T. Jozefowicz, Holly, MI (US)

(73) Assignee: GM GLOBAL TECHNOLOGY OPERATIONS LLC, Detroit, MI (US)

(21) Appl. No.: 15/668,013

(22) Filed: Aug. 3, 2017

(51) Int. Cl. G05B 23/02; G07C 5/08

(52) U.S. Cl. CPC G05B 23/0243; B60G 2800/802; G05B 23/0251; G07C 5/085

(57) ABSTRACT

Methods, systems, and vehicles are provided for controlling an active control system for a vehicle. In one embodiment, a method for controlling an active control system includes determining a health of a first control system, via a first processor of the first control system; determining a health of a second control system, via a second processor of the second control system; selectively controlling the active control system with instructions from the first control system or the second control system, based on the health of the first control system and the second control system; and selectively controlling communications from the first control system and the second control system, based on the health of the first control system and the second control system.

### TECHNICAL FIELD

The present disclosure generally relates to vehicles, and more particularly relates to methods and systems for controlling active control features for vehicles.

### BACKGROUND

Various vehicles today have different active control and warning features. However, it may be desirable to provide improved operation of active control and warning features under certain circumstances.

Accordingly, it is desirable to provide techniques for improved operation of active control systems, for example, in a case of a detected fault. Furthermore, other desirable features and characteristics of the inventive concept will be apparent from the subsequent detailed description and the appended claims, taken in conjunction with the accompanying drawings and the foregoing technical field and background.

### SUMMARY

In accordance with an exemplary embodiment, a method for controlling an active control system for a vehicle includes determining a health of a first control system, via a first processor of the first control system; determining a health of a second control system, via a second processor of the second control system; selectively controlling the active control system with instructions from the first control system or the second control system, based on the health of the first control system and the second control system; and selectively controlling communications from the first control system and the second control system, based on the health of the first control system and the second control system.

Also in one embodiment, when no faults are detected for the first and second control systems: the method provides that the active control system is controlled in a full operation mode in accordance with instructions provided by the first control system; and communications are provided from both the first control system and the second control system.

Also in one embodiment: (i) when a communication fault is determined with respect to the first control system: the active control system is controlled in a degraded mode in accordance with instructions provided by the second control system; and communications are provided from both the first control system and the second control system; and (ii) when a communication fault is determined with respect to the second control system: the active control system is controlled in the degraded mode in accordance with instructions provided by the first control system; and communications are provided from both the first control system and the second control system.

Also in one embodiment, when a critical fault is determined with respect to both the first control system and the second control system: the active control system is controlled in a degraded mode in accordance with instructions provided by the first control system; and communications are provided from both the first control system and the second control system.

Also in one embodiment: (i) when a critical fault is determined with respect to the first control system but not the second control system: the active control system is controlled in the degraded mode in accordance with instructions provided by the second control system; and communications are provided by the second control system but not by the first control system; and (ii) when a critical fault is determined with respect to the second control system but not the first control system: the active control system is controlled in the degraded mode in accordance with instructions provided by the first control system; and communications are provided by the first control system but not by the second control system.

Also in one embodiment, the active control system includes a steering system; and the step of selectively controlling the active control system includes selectively controlling an active control steering functionality of the steering system with instructions from the first control system or the second control system, based on the health of the first control system and the second control system.

Also in one embodiment, the active control system includes a braking system; and the step of selectively controlling the active control system includes selectively controlling an active control braking functionality of the braking system with instructions from the first control system or the second control system, based on the health of the first control system and the second control system.

In accordance with another exemplary embodiment, a system for controlling an active control system includes a first control system and a second control system. The first control system has a first processor that is configured to determine a health of the first control system. The second control has a second processor configured to determine a health of the second control system. The first control system and the second control system selectively control the active control system with instructions from the first control system or the second control system, based on the health of the first control system and the second control system. The first control system and the second control system selectively control communications from the first control system and the second control system based on the health of the first control system and the second control system.

Also in one embodiment, when no faults are detected for the first and second control systems: the system controls the active control system in a full operation mode in accordance with instructions provided by the first control system; and communications are provided from both the first control system and the second control system.

Also in one embodiment: (i) when a communication fault is determined with respect to the first control system: the active control system is controlled in a degraded mode in accordance with instructions provided by the second control system; and communications are provided from both the first control system and the second control system; and (ii) when a communication fault is determined with respect to the second control system: the active control system is controlled in the degraded mode in accordance with instructions provided by the first control system; and communications are provided from both the first control system and the second control system.

Also in one embodiment, when a critical fault is determined with respect to both the first control system and the second control system: the active control system is controlled in a degraded mode in accordance with instructions provided by the first control system; and communications are provided from both the first control system and the second control system.

Also in one embodiment: (i) when a critical fault is determined with respect to the first control system but not the second control system: the active control system is controlled in the degraded mode in accordance with instructions provided by the second control system; and communications are provided by the second control system but not by the first control system; and (ii) when a critical fault is determined with respect to the second control system but not the first control system: the active control system is controlled in the degraded mode in accordance with instructions provided by the first control system; and communications are provided by the first control system but not by the second control system.

Also in one embodiment, the active control system includes a steering system; and the first control system and the second control system are configured to selectively control an active control steering functionality of the steering system with instructions from the first control system or the second control system, based on the health of the first control system and the second control system.

Also in one embodiment, the active control system includes a braking system; and the first control system and the second control system are configured to selectively control an active control braking functionality of the braking system with instructions from the first control system or the second control system, based on the health of the first control system and the second control system.

In accordance with a further exemplary embodiment, a vehicle includes an active control system; a first control system; and a second control system. The first control system has a first processor configured to determine a health of the first control system. The second control system has a second processor configured to determine a health of the second control system. The first control system and the second control system selectively control the active control system with instructions from the first control system or the second control system, based on the health of the first control system and the second control system. The first control system and the second control system selectively control communications from the first control system and the second control system based on the health of the first control system and the second control system.

Also in one embodiment, when no faults are detected for the first and second control systems: the active safety system of the vehicle operates in a full operation mode in accordance with instructions provided by the first control system; and communications are provided from both the first control system and the second control system.

Also in one embodiment: (i) when a communication fault is determined with respect to the first control system: the active control system is controlled in a degraded mode in accordance with instructions provided by the second control system; and communications are provided from both the first control system and the second control system; and (ii) when a communication fault is determined with respect to the second control system: the active control system is controlled in the degraded mode in accordance with instructions provided by the first control system; and communications are provided from both the first control system and the second control system.

Also in one embodiment: (i) when a critical fault is determined with respect to both the first control system and the second control system: the active control system is controlled in a degraded mode in accordance with instructions provided by the first control system; and communications are provided from both the first control system and the second control system; (ii) when a critical fault is determined with respect to the first control system but not the second control system: the active control system is controlled in the degraded mode in accordance with instructions provided by the second control system; and communications are provided by the second control system but not by the first control system; and (iii) when a critical fault is determined with respect to the second control system but not the first control system: the active control system is controlled in the degraded mode in accordance with instructions provided by the first control system; and communications are provided by the first control system but not by the second control system.

Also in one embodiment, the active control system of the vehicle includes a steering system; and the first control system and the second control system of the vehicle are configured to selectively control an active control steering functionality of the steering system with instructions from the first control system or the second control system, based on the health of the first control system and the second control system.

Also in one embodiment, the active control system of the vehicle includes a braking system; and the first control system and the second control system of the vehicle are configured to selectively control an active control braking functionality of the braking system with instructions from the first control system or the second control system, based on the health of the first control system and the second control system.

### DESCRIPTION OF THE DRAWINGS

The present disclosure will hereinafter be described in conjunction with the following drawing figures, wherein like numerals denote like elements, and wherein:

FIG. 1 is a functional block diagram of an autonomous vehicle, and that includes an active control system along with primary and redundant controllers for the active control system, in accordance with exemplary embodiments; and

FIG. 2 is a flowchart of a process for controlling an active control system with primary and redundant controllers, and that can be used in connection with the vehicle, active control system, and controllers of FIG. 1, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

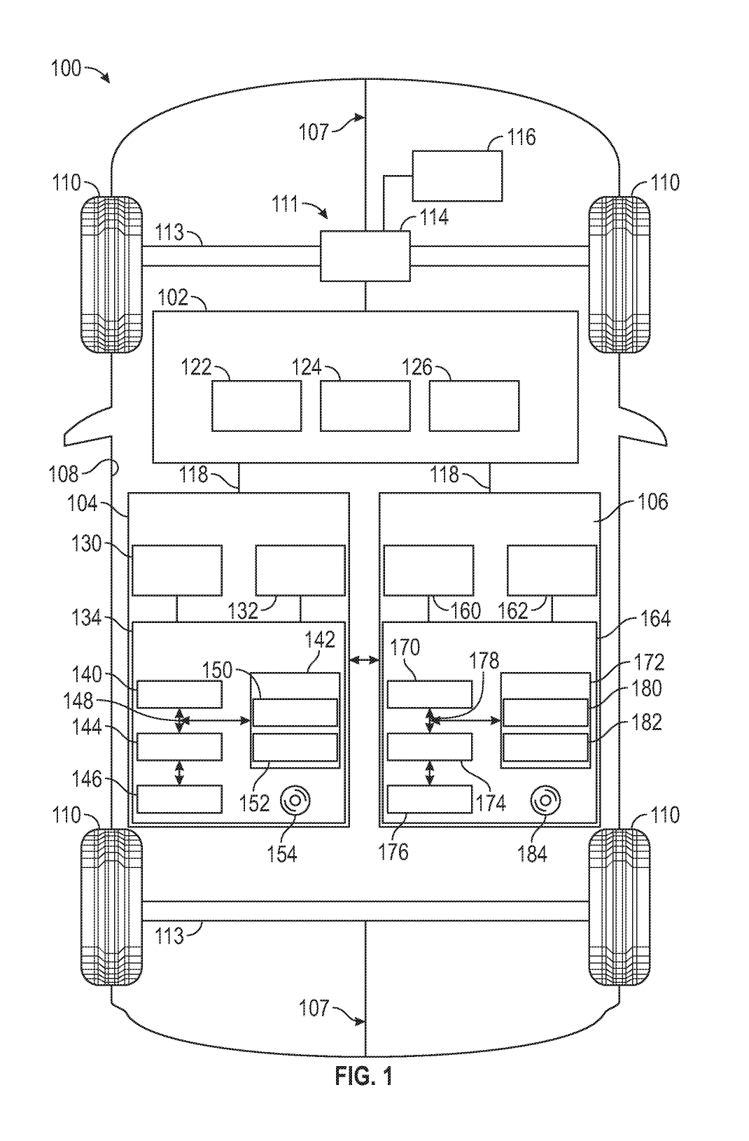

FIG. 1 illustrates a vehicle 100, or automobile, according to an exemplary embodiment. As described in greater detail below, the vehicle 100 includes an active control system 102 that is controlled via a primary (or first) control system 104 and a redundant (or second) control system 106. In various embodiment, the vehicle 100 comprises a land vehicle that operates on roadways. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD).

In one embodiment depicted in FIG. 1, the vehicle 100 includes, in addition to the above-referenced active control system 102, a primary control system 104, a redundant control system 106, a chassis 107, a body 108, four wheels 110, a powertrain assembly 111, and one or more other control systems 116 (e.g., an engine control system, an electronic control system, and/or various other control systems). The body 108 is arranged on the chassis 107 and substantially encloses the other components of the vehicle 100. The body 108 and the chassis 107 may jointly form a frame. The wheels 110 are each rotationally coupled to the chassis 107 near a respective corner of the body 108. As depicted in FIG. 1, each wheel 110 comprises a wheel assembly that includes a tire as well as a wheel and related components (and that are collectively referred to as the “wheel 110” for the purposes of this Application). In various embodiments the vehicle 100 may differ from that depicted in FIG. 1.

In the exemplary embodiment illustrated in FIG. 1, the powertrain assembly 111 includes an actuator assembly that includes an engine 114. In various other embodiments, the powertrain assembly 111 may vary from that depicted in FIG. 1 and/or described below (e.g. in some embodiments the powertrain may include a gas combustion engine 114, while in other embodiments the powertrain assembly 111 may include an electric motor, alone or in combination with one or more other powertrain assembly 111 components, for example for electric vehicles, hybrid vehicles, and the like). In one embodiment depicted in FIG. 1, the powertrain assembly 111 is mounted on the chassis 107 that drives the wheels 110. In one embodiment, the engine 114 comprises a combustion engine. In various other embodiments, the engine 114 may comprise an electric motor and/or one or more other transmission system components (e.g. for an electric vehicle), instead of or in addition to the combustion engine.

Still referring to FIG. 1, in one embodiment, the engine 114 is coupled to at least some of the wheels 110 through one or more drive shafts 113. In some embodiments, the engine 114 is mechanically coupled to the transmission. In other embodiments, the engine 114 may instead be coupled to a generator used to power an electric motor that is mechanically coupled to the transmission. In certain other embodiments (e.g. electrical vehicles), an engine and/or transmission may not be necessary.

The active control system 102 performs various active control features for the vehicle 100. For example, in various embodiments, the active control system 102 performs features that include steering assist, braking assist, lane changing, lane keeping, and object detection, among other possible active control features. In various embodiments, the active control system 102 includes a steering system 122, a braking system 124, and/or one or more other systems 126 (e.g., a communication or alert system, and/or one or more other systems).

In various embodiments, the steering system 122 is mounted on the chassis 107, and controls steering of the wheels 110. In various embodiments, the vehicle 100 automatically controls steering of the vehicle 100 (including automatic steering, steering assist, lane changing, lane keeping, obstacle avoidance, and/or other active control steering functionality) via instructions provided from the control systems 104, 106 to the steering system 122. In certain embodiments, the steering system 122 comprises an electronic power steering (EPS) system.

The braking system 124 is mounted on the chassis 107, and provides braking for the vehicle 100. In various embodiments, the vehicle 100 automatically controls braking of the vehicle 100 (including automatic braking, braking assist, panic braking, obstacle avoidance, and/or other active control braking functionality) via instructions provided from the control systems 104, 106 to the braking system 124.

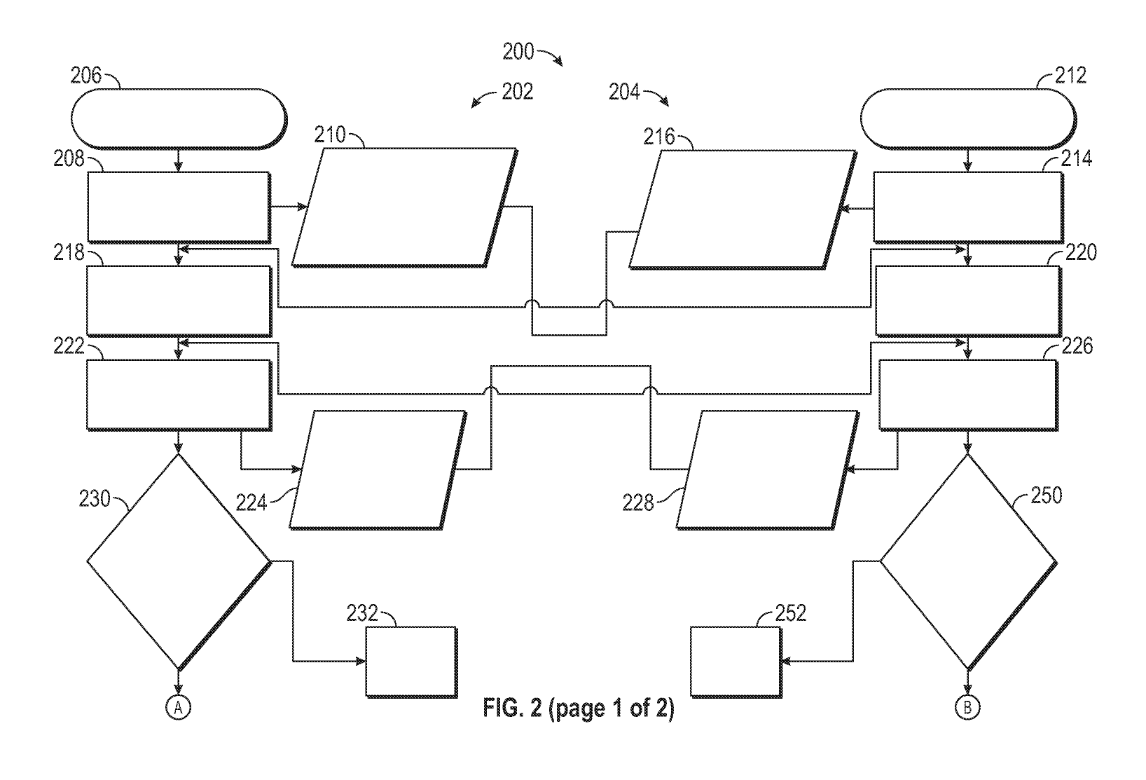

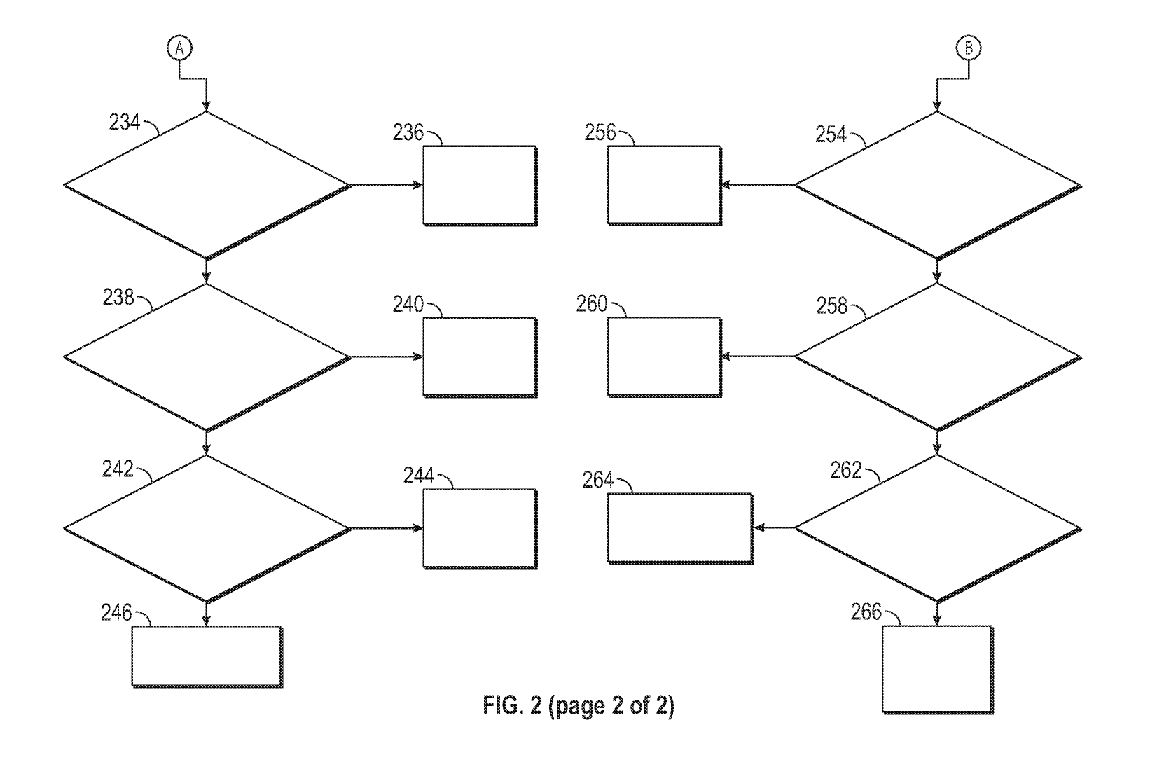

In one embodiment, the control systems 104, 106 are mounted on the chassis 107. The control systems 104, 106 control the active control system 102. In addition, the control systems 104, 106 monitor the health of the control systems 104, 106 and provide arbitration for control of the active control system 102 via the control systems, and communications from the control systems 104, 106, in accordance with the steps of the process 200 depicted in FIG. 2 and described further below in connection therewith.

In various embodiments, the primary control system 104 and the redundant control system 106 include similar features to one another. Both the primary control system 104 and the redundant control system 106 will be discussed in turn below in accordance with various embodiments.

As depicted in FIG. 1, in one embodiment the primary control system 104 comprises various sensors 130 (also referred to herein as a sensor array), a transceiver 132, and a controller 134. The sensors 130 include various sensors that provide measurements for use in controlling steering, braking, and/or other active control features for the vehicle 100.

The transceiver 132 facilitates communications with the redundant control system 106. In various embodiments, the transceiver 132 provides transmissions to the redundant control system 106 regarding a health status of the primary control system 104. Also in various embodiments, the transceiver 132 receives transmissions from the redundant control system 106 regarding a health status of the redundant control system 106.

The controller 134 is coupled to the sensors 130 and the transceiver 132. The controller 134 utilizes information from the sensors 130 and the transceiver 132 to ascertain a health of the primary control system 104 and the redundant control system 106, performs arbitration with respect to control of the active control system 102 via the primary control system 104 and the redundant control system 106, and provides instructions as appropriate for control of the active control system 102. In certain embodiments, the instructions may be sent from the controller 134 to the active control system 102 via a communication link 118, such as a vehicle CAN bus and/or via one or more wireless communication networks, such as via one or more Internet, satellite, cellular, and/or short range (e.g. BlueTooth) networks, systems, and/or devices.

As depicted in FIG. 1, the controller 134 comprises a computer system. In certain embodiments, the controller 134 may also include one or more of the sensors of the sensors 130, transceiver 132, and/or components thereof. In addition, it will be appreciated that the controller 134 may otherwise differ from the embodiment depicted in FIG. 1. For example, the controller 134 may be coupled to or may otherwise utilize one or more remote control systems (e.g., one or more other control systems 116) and/or one or more other systems of the vehicle 100.

In the depicted embodiment, the computer system of the controller 134 includes a processor 140, a memory 142, an interface 144, a storage device 146, and a bus 148. The processor 140 performs the computation and control functions of the controller 134, and may comprise any type of processor or multiple processors, single integrated circuits such as a microprocessor, or any suitable number of integrated circuit devices and/or circuit boards working in cooperation to accomplish the functions of a processing unit. During operation, the processor 140 executes one or more programs 150 contained within the memory 142 and, as such, controls the general operation of the controller 134 and the computer system of the controller 134, generally in executing the processes described herein, such as those described further below in connection with FIG. 2.

The memory 142 can be any type of suitable memory. For example, the memory 142 may include various types of dynamic random access memory (DRAM) such as SDRAM, the various types of static RAM (SRAM), and the various types of non-volatile memory (PROM, EPROM, and flash). In certain examples, the memory 142 is located on and/or co-located on the same computer chip as the processor 140. In the depicted embodiment, the memory 142 stores the above-referenced program 150 along with stored values 152 for monitoring the health of the primary control system 104 and the redundant control system 106 and for controlling the active control system 102.

The bus 148 serves to transmit programs, data, status and other information or signals between the various components of the computer system of the controller 134. The interface 144 allows communication to the computer system of the controller 134, for example from a system driver and/or another computer system, and can be implemented using any suitable method and apparatus. In one embodiment, the interface 144 obtains the various data from the sensors of the sensors 130. The interface 144 can include one or more network interfaces to communicate with other systems or components. The interface 144 may also include one or more network interfaces to communicate with technicians, and/or one or more storage interfaces to connect to storage apparatuses, such as the storage device 146.

The storage device 146 can be any suitable type of storage apparatus, including direct access storage devices such as hard disk drives, flash systems, floppy disk drives and optical disk drives. In one exemplary embodiment, the storage device 146 comprises a program product from which memory 142 can receive a program 150 that executes one or more embodiments of one or more processes of the present disclosure, such as the steps described further below in connection with FIG. 2. In another exemplary embodiment, the program product may be directly stored in and/or otherwise accessed by the memory 142 and/or a disk (e.g., disk 154), such as that referenced below.

The bus 148 can be any suitable physical or logical means of connecting computer systems and components. This includes, but is not limited to, direct hard-wired connections, fiber optics, infrared and wireless bus technologies. During operation, the program 150 is stored in the memory 142 and executed by the processor 140.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 140) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 134 may also otherwise differ from the embodiment depicted in FIG. 1, for example in that the computer system of the controller 134 may be coupled to or may otherwise utilize one or more remote computer systems and/or other systems.

Similarly, the redundant control system 106 includes various sensors 160 (also referred to herein as a sensor array), a transceiver 162, and a controller 164. The sensors 160, similar to the sensors 130 of the primary control system 104, include various sensors that provide measurements for use in controlling steering, braking, and/or other active control features for the vehicle 100.

The transceiver 162 facilitates communications with the primary control system 104. In various embodiments, the transceiver 162 provides transmissions to the primary control system 104 regarding a health status of the redundant control system 106. Also in various embodiments, the transceiver 162 receives transmissions from the primary control system 104 regarding a health status of the primary control system 104.

The controller 164 is coupled to the sensors 160 and the transceiver 162. The controller 164 utilizes information from the sensors 160 and the transceiver 162 to ascertain a health of the redundant control system 106 and the primary control system 104, performs arbitration with respect to control of the active control system 102 via the redundant control system 106 and the primary control system 104, and provides instructions as appropriate for control of the active control system 102. In certain embodiments, the instructions may be sent from the controller 164 to the active control system 102 via a communication link 118, such as a vehicle CAN bus and/or via one or more wireless communication networks, such as via one or more Internet, satellite, cellular, and/or short range (e.g. BlueTooth) networks, systems, and/or devices.

As depicted in FIG. 1, the controller 164 comprises a computer system. In certain embodiments, the controller 164 may also include one or more of the sensors of the sensors 160, transceiver 162, and/or components thereof. In addition, it will be appreciated that the controller 164 may otherwise differ from the embodiment depicted in FIG. 1. For example, the controller 164 may be coupled to or may otherwise utilize one or more remote control systems (e.g., one or more other control systems 116) and/or one or more other systems of the vehicle 100.

In the depicted embodiment, the computer system of the controller 164 is similar in structure and function to the controller 134 of the primary control system 104, and includes a processor 170, a memory 172, an interface 174, a storage device 176, and a bus 178.

The processor 170 performs the computation and control functions of the controller 164, and is similar in structure and function to the processor 140 of the primary control system 104. The memory 172 is similar in structure and function to the memory 142 of the primary control system 104, and includes a similar program 180 and stored values 182. The interface 174 and the bus 178 are similar to the interface 144 and bus 148, respectively, of the primary control system 104. The storage device 176 is similar to the storage device 146 of the primary control system 104, and may include, by way of example, a similar disk 184, and so on.

It will be appreciated that in various embodiments the vehicle 100 can be operated via instructions provided by one or more human drivers or operators, or in an automated manner by commands, instructions, and/or inputs that are “self-generated” onboard the vehicle itself. Alternatively or additionally, the vehicle 100 can be controlled by commands, instructions, and/or inputs that are generated by one or more components or systems external to the vehicle 100, including, without limitation: other autonomous vehicles; a backend server system; a control device or system located in the operating environment; or the like. In certain embodiments, therefore, the vehicle 100 can be controlled using vehicle-to-vehicle data communication, vehicle-to-infrastructure data communication, and/or infrastructure-to-vehicle communication, among other variations (including partial or complete control by the driver or other operator in certain modes, for example as discussed above).

With reference to FIG. 2, a flowchart is provided for a process 200 for controlling an active control system with primary and redundant controllers, in accordance with various embodiments. The process 200 can be utilized in connection with the vehicle 100, the active control system 102, and the primary and redundant control systems 104, 106 of FIG. 1, in accordance with exemplary embodiment.

As depicted in FIG. 2, the process 200 begins along two respective paths 202, 204. In various embodiments, the first path 202 is performed via the primary control system 104, and the second path 204 is performed via the redundant control system 106 of FIG. 1. In one embodiment, the process 200 begins when an autonomous vehicle is in operation, for example, when the vehicle is in a “drive mode”, moving along a path or roadway, and/or ready for movement along a desired path. Also in various embodiments, the first path and the second path 202, 204 are performed simultaneously, or at least substantially simultaneously, with one another.

In various embodiments, the first path 202 begins with step 206. During step 206, the primary control system 104 of FIG. 1 is started, or initiated.

A determination is made as to a fault status of the primary control system (step 208). In various embodiments, the controller 134 of FIG. 1 performs internal diagnostics for the primary control system 104 using data from the sensors 130 and/or the processor 140 of FIG. 1. Also in various embodiments, the controller 134 (e.g., the processor 140 thereof) performs checks as to any faults in the processor 140 itself. Also in certain embodiments, similar checks are performed as to any other faults in the primary control system 104, such as the sensors 130, the transceiver 132, and/or the memory 142.

Communication of the fault status is made to the redundant control system 106 (step 210). Specifically, in various embodiments, during step 210, the primary control system 104 transmits messages via the transceiver 132, via instructions provided by the processor 140, to the redundant control system 106 of FIG. 1.

Similarly, in various embodiments, the second path 204 begins with step 212. During step 212, the redundant control system 106 of FIG. 1 is started, or initiated.

As the second path 204 continues, a determination is made as to a fault status of the redundant control system (step 214). In various embodiments, the controller 164 of FIG. 1 performs internal diagnostics for the redundant control system 106 using data from the sensors 160 and/or the processor 170 of FIG. 1. Also in various embodiments, the controller 164 (e.g., the processor 170 thereof) performs checks as to any faults in the processor 170 itself. Also in certain embodiments, similar checks are performed as to any other faults in the primary control system 104, such as the sensors 160, the transceiver 162, and/or the memory 172.

Communication of the fault status is made to the primary control system 104 (step 216). Specifically, in various embodiments, during step 216, the redundant control system 106 transmits messages via the transceiver 162, via instructions provided by the processor 170, to the primary control system 104 of FIG. 1.

The respective communications as to the respective faults statuses are received at steps 218 and 220. Specifically, at step 218, the primary control system 104 receives the communication from step 216 as to the fault status of the redundant control system 106. Similarly, at step 220, the redundant control system 106 receives the communication from step 210 as to the fault status of the primary control system 104. In various embodiments, the communications are received at steps 218 and 220 via the respective transceivers 132, 162 of the primary and redundant control systems 104, 106.

In various embodiments, respective arbitration routines are performed by the primary and redundant control systems 104, 106 based on the received communications regarding the other controller, as discussed below. Specifically, in various embodiments, the primary control system 104 (e.g., via the processor 140) initiates a primary controller arbitration routine (step 222), and communicates a stop command request and stop command authorization to the redundant control system 106 (step 224) (e.g., via the transceiver 132, based on instructions from the processor 140). Similarly, also in various embodiments, the redundant control system 106 (e.g., via the processor 170) initiates a redundant controller arbitration routine (step 226), and communicates a stop command request and stop command authorization to the primary control system 104 (step 228) (e.g., via the transceiver 162, based on instructions from the processor 170).

Also in various embodiments, the communications of step 228 from the redundant control system 106 are utilized by the primary control system 104 in the primary controller arbitration routine in subsequent iterations of step 222. Similarly, also in various embodiments, the communications of step 224 from the primary control system 104 are utilized by the redundant control system 106 in the redundant controller arbitration routine in subsequent iterations of step 226.

In various embodiments, the first path 202 continues with step 230. Specifically, during step 230, a determination is made by the primary controller 134 (e.g., by the processor 140 thereof) as to whether a critical fault has been detected for either the primary control system 104 and/or the redundant control system 106. In certain embodiments, as used throughout this Application, a critical fault refers to a fault in a respective processor of the control system, and/or a fault in another component of the respective control system that would be believed to significantly compromise operation of the respective control system.

If it is determined in step 230 that there is no critical fault in any of the primary or redundant control systems 104, 106 (i.e., that neither control system has a critical fault), then the process proceeds to step 232. During step 232, the active control system 102 of FIG. 1 is controlled in a normal or typical mode of operation (e.g., a mode of operation in which there are no significant faults), in which the active control features are fully functional. Also during step 232, the active control system 102 is controlled in this many via the primary control system 104. For example, in various embodiments, steering, braking, and/or other commands are provided via the processor 140 of the primary control system 104 and/or implemented via the steering system 122, the braking system 124, and/or other systems 126 of the active control system of FIG. 1 with full active control functionality. For example, during step 232, various active control functionality of the steering system 122, braking system 124, and/or other systems 126 of the active control system 102 of FIG. 1 (e.g., including automatic steering, steering assist, lane changing, lane keeping, obstacle avoidance, automatic braking, braking assist, panic braking, obstacle avoidance, and/or other active control braking functionality) are provided with full functionality as appropriate during step 232. Also in various embodiments, the primary control system 104 continues communicating as normal, including providing instructions (i.e., control commands) for the active control system 102.

Conversely, if it is instead determined in step 230 that there is a critical fault in one or both of the primary or redundant control systems 104, 106 (i.e., that at least one control system has a critical fault), then the process proceeds instead to step 234. During step 234, a determination is made by the primary controller 134 (e.g., by the processor 140 thereof) as to whether a communication fault has occurred with respect to communications from the redundant control system 106 and/or whether an arbitration was not received from the redundant control system 106.

If it is determined in step 234 that a communication fault has occurred with respect to communications from the redundant control system 106, or that an arbitration was not received from the redundant control system 106, or both, then the process proceeds to step 236. During step 236, the active control system 102 is operated in a degraded mode. For example, in various embodiments, steering, braking, and/or other commands are provided via the processor 140 of the primary control system 104 and/or implemented via the steering system 122, the braking system 124, and/or other systems 126 of the active control system of FIG. 1 with only partial active control functionality. For example, in certain embodiments, if a current function of the active control system 102 (for example, automatic steering, steering assist, lane changing, lane keeping, obstacle avoidance, automatic braking, braking assist, panic braking, obstacle avoidance, and/or other active control braking functionality) has not been initiated, then a new initiation of such feature may not be begun while the active control system 102 is in the degraded mode. Also in certain embodiments, if a current function of the active control system 102 (for example, automatic steering, steering assist, lane changing, lane keeping, obstacle avoidance, automatic braking, braking assist, panic braking, obstacle avoidance, and/or other active control braking functionality) has already been initiated, then such function may be effectively reduced, gradually turned off, and/or gradually ramped down to another safe state of operation. Also in various embodiments, during step 234, the primary control system 104 remains in control of the active control system 102. In addition, the primary control system 104 continues communicating as normal, including providing instructions (i.e., control commands) for the active control system 102.

Conversely, if it is determined in step 234 that no communication fault has occurred with respect to communications from the redundant control system 106 and that the arbitration was received from the redundant control system 106, then the process proceeds instead to step 238. During step 238, a determination is made by the primary controller 134 (e.g., by the processor 140 thereof) as to whether a critical fault has been detected on both the primary control system 104 and the redundant control system 106.

If it is determined in step 238 that a critical fault has been detected on both the primary control system 104 and the redundant control system 106, then the process proceeds to step 240. During step 240, the active control system 102 is operated in a degraded mode. In various embodiments, the degraded mode is similar to that of step 236, described above. Also in various embodiments, during step 240, the primary control system 104 remains in control of the active control system 102. Also in various embodiments, during step 240, the primary control system 104 continues communicating as normal, including providing instructions (i.e., control commands) for the active control system 102.

Conversely, if it is determined in step 238 that critical faults have not been detected for both of the control systems 104, 106 (i.e., that at least one of the control systems 104, 106 does not have a critical fault), then the process proceeds instead to step 242. During step 242, a determination is made by the primary controller 134 (e.g., by the processor 140 thereof) as to whether a critical fault has been detected for the primary control system 104 (e.g., a critical fault of the processor 140).

If it is determined in step 242 that a critical fault has not been detected on the primary control system 104, then the process proceeds to step 244. During step 244, the redundant control system 106 is determined to have a critical fault. During step 244, the active control system 102 is operated in a degraded mode. In various embodiments, the degraded mode is similar to that of step 236, described above. Also in various embodiments, during step 244, the primary control system 104 remains in control of the active control system 102. Also in various embodiments, during step 244, the primary control system 104 continues communicating as normal, including providing instructions (i.e., control commands) for the active control system 102.

Conversely, if it is determined in step 242 that a critical fault has been detected on the primary control system 104, then the process proceeds instead to step 246. During step 246, communications are turned off for the primary control system 104. Specifically, in various embodiments, the primary control system 104 stops sending control commands for the active control system 102. Also in various embodiments, during step 246 the active control system 102 is operated in a degraded mode. In various embodiments, the degraded mode is similar to that of step 236, described above (e.g., the non-initiation of new features and the ramping down of existing features, and so on), except that the redundant control system 106 remains in control of the active control system 102, and communications are turned off for the primary control system 104. In various embodiments, during step 246, while the primary control system 104 stops communicating instructions for the active control system 102, the redundant control system 106 continues communicating instructions for the active control system 102.

With reference back to the discussion of steps 222-228 above, in various embodiments, just as the first path 202 continues with step 230, the second path 204 similarly continues with step 250. Specifically, during step 250, a determination is made by the redundant controller 164 (e.g., by the processor 170 thereof) as to whether a critical fault has been detected for either the primary control system 104 and/or the redundant control system 106.

If it is determined in step 250 that there is no critical fault in any of the primary or redundant control systems 104, 106 (i.e., that neither control system has a critical fault), then the process proceeds to step 252. During step 252, the active control system 102 of FIG. 1 is controlled in a normal or typical mode of operation (e.g., a mode of operation in which there are no significant faults), similar to that described above in connection with step 232. Also during step 252, the active control system 102 is controlled in this many via the primary control system 104, also similar to step 232. Also in various embodiments, the redundant control system 106 continues communicating as normal, including providing instructions (i.e., control commands) for the active control system 102.

Conversely, if it is instead determined in step 250 that there is a critical fault in one or both of the primary or redundant control systems 104, 106 (i.e., that at least one control system has a critical fault), then the process proceeds instead to step 254. During step 254, a determination is made by the redundant controller 164 (e.g., by the processor 170 thereof) as to whether a communication fault has occurred with respect to communications from the primary control system 104 and/or whether an arbitration was not received from the primary control system 104.

If it is determined in step 254 that a communication fault has occurred with respect to communications from the primary control system 104, or that an arbitration was not received from the primary control system 104, or both, then the process proceeds to step 256. During step 256, the active control system 102 is operated in a degraded mode, similar to the degraded mode of step 236, described above. Also in various embodiments, during step 256, the primary control system 104 remains in control of the active control system 102. In addition, the redundant control system 106 continues communicating as normal, including providing instructions (i.e., control commands) for the active control system 102.

Conversely, if it is determined in step 254 that no communication fault has occurred with respect to communications from the primary control system 104 and that the arbitration was received from the primary control system 104, then the process proceeds instead to step 258. During step 258, a determination is made by the redundant controller 164 (e.g., by the processor 170 thereof) as to whether a critical fault has been detected on both the primary control system 104 and the redundant control system 106.

If it is determined in step 258 that a critical fault has been detected on both the primary control system 104 and the redundant control system 106, then the process proceeds to step 260. During step 260, the active control system 102 is operated in a degraded mode. In various embodiments, the degraded mode is similar to that of step 236, described above. Also in various embodiments, during step 260, the primary control system 104 remains in control of the active control system 102. In addition, the redundant control system 106 continues communicating as normal, including providing instructions (i.e., control commands) for the active control system 102.

Conversely, if it is determined in step 258 that critical faults have not been detected for both of the control systems 104, 106 (i.e., that at least one of the control systems 104, 106 does not have a critical fault), then the process proceeds instead to step 262. During step 262, a determination is made by the redundant controller 164 (e.g., by the processor 170 thereof) as to whether a critical fault has been detected for the primary control system 104 (e.g., a critical fault of the processor 140).

If it is determined in step 262 that a critical fault has not been detected on the primary control system 104, then the process proceeds to step 264. During step 264, the redundant control system 106 is determined to have a critical fault. Communications are turned off for the redundant control system 106. Specifically, in various embodiments, the redundant control system 106 continues performing calculations, but stops sending instructions (i.e., control commands) for the active control system 102. Also during step 264, in various embodiments the active control system 102 is operated in a degraded mode. In various embodiments, the degraded mode is similar to that of step 236, described above, except that communications have been turned off for the redundant control system 106 (while the primary control system 104 continues sending instructions for the active control system 102). Also in various embodiments, during step 244, the primary control system 104 remains in control of the active control system 102.

Conversely, if it is determined in step 262 that a critical fault has been detected on the primary control system 104, the process proceeds instead to step 266. During step 266, the active control system 102 is operated in a degraded mode. In various embodiments, the degraded mode is similar to that of step 236, described above, except that the active control system 102 is controlled by the redundant control system 106 instead of the primary control system 104. Also in various embodiments, during step 266, the redundant control system 106 continues communicating as normal, including providing instructions (i.e., control commands) for the active control system 102.

Accordingly, methods, systems, and vehicles are disclosed that provide for control of an active control system of a vehicle using a primary control system and a redundant control system. In various embodiments, the primary and redundant control systems monitor their own health as well as the health of the other control system, and coordinate communications between the control systems and control of the active control system using arbitration procedures implemented by the primary and redundant control systems based on the health of the primary and redundant control systems.

It will be appreciated that the disclosed methods, systems, and vehicles may vary from those depicted in the Figures and described herein. For example, the vehicle 100, the active control system, the control systems, and/or various components thereof may vary from that depicted in FIG. 1 and described in connection therewith. It will similarly be appreciated that the steps of the process 200 may differ from and/or be performed in a different order than that depicted in FIG. 2 and described in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method for controlling an active control system for a vehicle, the method comprising:
determining a health of a first control system, via a first processor of the first control system;
determining a health of a second control system, via a second processor of the second control system;
selectively controlling the active control system with instructions from the first control system or the second control system, based on the health of the first control system and the second control system; and
selectively controlling communications from the first control system and the second control system, based on the health of the first control system and the second control system.

2. The method of claim 1, wherein, when no faults are detected for the first and second control systems:
the active control system is controlled in a full operation mode in accordance with instructions provided by the first control system; and
communications are provided from both the first control system and the second control system.

3. The method of claim 2, wherein:
when a communication fault is determined with respect to the first control system:
the active control system is controlled in a degraded mode in accordance with instructions provided by the second control system; and
communications are provided from both the first control system and the second control system; and
when a communication fault is determined with respect to the second control system:
the active control system is controlled in the degraded mode in accordance with instructions provided by the first control system; and
communications are provided from both the first control system and the second control system.

4. The method of claim 2, wherein, when a critical fault is determined with respect to both the first control system and the second control system:
the active control system is controlled in a degraded mode in accordance with instructions provided by the first control system; and
communications are provided from both the first control system and the second control system.

5. The method of claim 4, wherein:
when a critical fault is determined with respect to the first control system but not the second control system:
the active control system is controlled in the degraded mode in accordance with instructions provided by the second control system; and
communications are provided by the second control system but not by the first control system; and
when a critical fault is determined with respect to the second control system but not the first control system:
the active control system is controlled in the degraded mode in accordance with instructions provided by the first control system; and
communications are provided by the first control system but not by the second control system.

6. The method of claim 1, wherein:
the active control system comprises a steering system; and
the step of selectively controlling the active control system comprises selectively controlling an active control steering functionality of the steering system with instructions from the first control system or the second control system, based on the health of the first control system and the second control system.

7. The method of claim 1, wherein:
the active control system comprises a braking system; and
the step of selectively controlling the active control system comprises selectively controlling an active control braking functionality of the braking system with instructions from the first control system or the second control system, based on the health of the first control system and the second control system.

8. A system for controlling an active control system for a vehicle, the system comprising:
a first control system, the first control system having a first processor configured to determine a health of the first control system; and
a second control system, the second control system having a second processor configured to determine a health of the second control system;
wherein the first control system and the second control system selectively control the active control system with instructions from the first control system or the second control system, based on the health of the first control system and the second control system; and
wherein the first control system and the second control system selectively control communications from the first control system and the second control system based on the health of the first control system and the second control system.

9. The system of claim 8, wherein, when no faults are detected for the first and second control systems:
the active control system is controlled in a full operation mode in accordance with instructions provided by the first control system; and
communications are provided from both the first control system and the second control system.

10. The system of claim 9, wherein:
when a communication fault is determined with respect to the first control system:
the active control system is controlled in a degraded mode in accordance with instructions provided by the second control system; and
communications are provided from both the first control system and the second control system; and
when a communication fault is determined with respect to the second control system:
the active control system is controlled in the degraded mode in accordance with instructions provided by the first control system; and
communications are provided from both the first control system and the second control system.

11. The system of claim 9, wherein, when a critical fault is determined with respect to both the first control system and the second control system:
the active control system is controlled in a degraded mode in accordance with instructions provided by the first control system; and
communications are provided from both the first control system and the second control system.

12. The system of claim 11, wherein;
when a critical fault is determined with respect to the first control system but not the second control system:
the active control system is controlled in the degraded mode in accordance with instructions provided by the second control system; and
communications are provided by the second control system but not by the first control system; and
when a critical fault is determined with respect to the second control system but not the first control system:
the active control system is controlled in the degraded mode in accordance with instructions provided by the first control system; and
communications are provided by the first control system but not by the second control system.

13. The system of claim 8, wherein:
the active control system comprises a steering system; and
the first control system and the second control system are configured to selectively control an active control steering functionality of the steering system with instructions from the first control system or the second control system, based on the health of the first control system and the second control system.

14. The system of claim 8, wherein:
the active control system comprises a braking system; and
the first control system and the second control system are configured to selectively control an active control braking functionality of the braking system with instructions from the first control system or the second control system, based on the health of the first control system and the second control system.

15. A vehicle comprising:
an active control system;
a first control system, the first control system having a first processor configured to determine a health of the first control system; and
a second control system, the second control system having a second processor configured to determine a health of the second control system;
wherein the first control system and the second control system selectively control the active control system with instructions from the first control system or the second control system, based on the health of the first control system and the second control system; and
wherein the first control system and the second control system selectively control communications from the first control system and the second control system based on the health of the first control system and the second control system.

16. The vehicle of claim 15, wherein, when no faults are detected for the first and second control systems:
the active control system is controlled in a full operation mode in accordance with instructions provided by the first control system; and
communications are provided from both the first control system and the second control system.

17. The vehicle of claim 16, wherein:
when a communication fault is determined with respect to the first control system:
the active control system is controlled in a degraded mode in accordance with instructions provided by the second control system; and
communications are provided from both the first control system and the second control system; and
when a communication fault is determined with respect to the second control system:
the active control system is controlled in the degraded mode in accordance with instructions provided by the first control system; and
communications are provided from both the first control system and the second control system.

18. The vehicle of claim 16, wherein:
when a critical fault is determined with respect to both the first control system and the second control system:
the active control system is controlled in a degraded mode in accordance with instructions provided by the first control system; and
communications are provided from both the first control system and the second control system;
when a critical fault is determined with respect to the first control system but not the second control system:
the active control system is controlled in the degraded mode in accordance with instructions provided by the second control system; and
communications are provided by the second control system but not by the first control system; and
when a critical fault is determined with respect to the second control system but not the first control system:
the active control system is controlled in the degraded mode in accordance with instructions provided by the first control system; and
communications are provided by the first control system but not by the second control system.

19. The vehicle of claim 15, wherein:
the active control system comprises a steering system; and
the first control system and the second control system are configured to selectively control an active control steering functionality of the steering system with instructions from the first control system or the second control system, based on the health of the first control system and the second control system.

20. The vehicle of claim 15, wherein:
the active control system comprises a braking system; and
the first control system and the second control system are configured to selectively control an active control braking functionality of the braking system with instructions from the first control system or the second control system, based on the health of the first control system and the second control system.
